(19) United States
(12) Patent Application Publication
(10) Pub. No.: US 2018/0093599 A1
(43) Pub. Date: Apr. 5, 2018

(54) FOLDABLE AUTOMOTIVE ANTIFOULING MAT STRUCTURE

(71) Applicant: FORMOSA SAINT JOSE CORP., Taipei (TW)

(72) Inventor: Ming-Shun Yang, Taipei (TW)

(73) Assignee: FORMOSA SAINT JOSE CORP., Taipei (TW)

(21) Appl. No.: 15/355,196

(22) Filed: Nov. 18, 2016

(30) Foreign Application Priority Data
Sep. 30, 2016 (TW) 105132015

(51) Int. Cl. B60N 3/04

(52) U.S. Cl. CPC B60N 3/048; B60N 3/044

(57) ABSTRACT

The present invention discloses a foldable automotive antifouling mat structure, including a mat body, at least one first folding line forming on the mat body, and at least one second folding line forming on the mat body and is perpendicularly crossing the first folding line. With the implementation of the present invention, the foldable automotive antifouling mat structure can be folded, can be used on a car, a truck, a van, a SUV or a pick up as a chamber mat or cargo mat to provide perfect antifouling function, and most of all, due to its folding characteristics, the required space for packing, storage, or delivery can be greatly reduced that greatly reduces the cost and the possibility of impacts, bending or deformation in storage or transporting.

### BACKGROUND OF THE INVENTION

### 1. Technical Field

The present invention relates to automotive antifouling mat structure, and more particularly, to a foldable automotive antifouling mat structure.

### 2. Description of Related Art

As cars are in wide use nowadays, consumers' demand for preventing pollution of car interior, costing down the budget for cleansing or preventing causes of danger due to falling debris into the mechanical or electronic parts is continuously increasing.

Thus antifouling mats that meet those requirements came into being. And as the growing needs for varieties of car models, such as SUV, VAN, truck or pickups, antifouling mats with different shapes or sizes that meet different requirements are being designed and produced. However, known antifouling mats are hardly foldable that results in the enormously large space requiring for packing, storage or transportation, and the susceptibility of antifouling mats being damaged, bent or deformed while packing, storing or transporting.

Accordingly, it is imperative to provide a foldable automotive antifouling mat structure which is effectively foldable in storing, capable of providing pollution resistance of the car interior or cargo area in its entirety, and reducing the space required while preventing possible impacts, bending or deformation when in packing, storage or transportation, and thus meets automakers' progress and expectations in terms of low costs and high efficiency.

### SUMMARY OF THE INVENTION

The present invention discloses a foldable automotive antifouling mat structure, including a mat body, at least one first folding line forming on the mat body, and at least one second folding line forming on the mat body and is perpendicularly crossing the first folding line. With the implementation of the present invention, the foldable automotive antifouling mat structure can be folded, can be used on a car, a truck, a van, a SUV or a pick up as a chamber mat or cargo mat to provide perfect antifouling function, and most of all, due to its folding characteristics, the required space for packing, storage, or delivery can be greatly reduced that greatly reduces the cost and the possibility of impacts, bending or deformation in storage or transporting.

The present invention discloses a foldable automotive antifouling mat structure, comprising: a mat body, including an upper surface, a bottom surface opposites to the upper surface and plural edges at the rim of the mat body; at least one first folding line, forming on the upper surface; and at least one second folding line, forming on the upper surface and being perpendicularly crossing the first folding line.

Implementation of the present invention at least involves the following inventive steps:

1. Making antifouling mat easily and repeatedly foldable.

2. Providing car chamber or truck platform with antifouling capability.

3. Reducing the space and cost required for packing, storage or transportation of antifouling mat.

4. Avoiding impact, bending or deformation of antifouling mat during transportation or storing.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a three dimensional schematic view of a foldable automotive antifouling mat structure according to an embodiment of the present invention.

FIG. 2 is a three dimensional schematic view of a foldable automotive antifouling mat structure bended from a first folding line according to an embodiment of the present invention.

FIG. 3 is a three dimensional schematic view of the foldable automotive antifouling mat structure of FIG. 2 further bended from second folding lines according to an embodiment of the present invention.

FIG. 4 is a schematic view of a foldable automotive antifouling mat structure with at least one folding trench formed on the upper surface according to an embodiment of the present invention.

FIG. 5 is a schematic view of a foldable automotive antifouling mat structure with at least one pattern formed on the upper surface of the mat body according to an embodiment of the present invention.

FIG. 6 is a schematic view of another foldable automotive antifouling mat structure with at least one pattern formed on the upper surface of the mat body according to an embodiment of the present invention.

FIG. 7 is a schematic view of a foldable automotive antifouling mat structure with at least one anti-skid structure formed on the bottom surface of the mat body according to an embodiment of the present invention.

### DETAILED DESCRIPTION OF THE EMBODIMENTS OF THE INVENTION

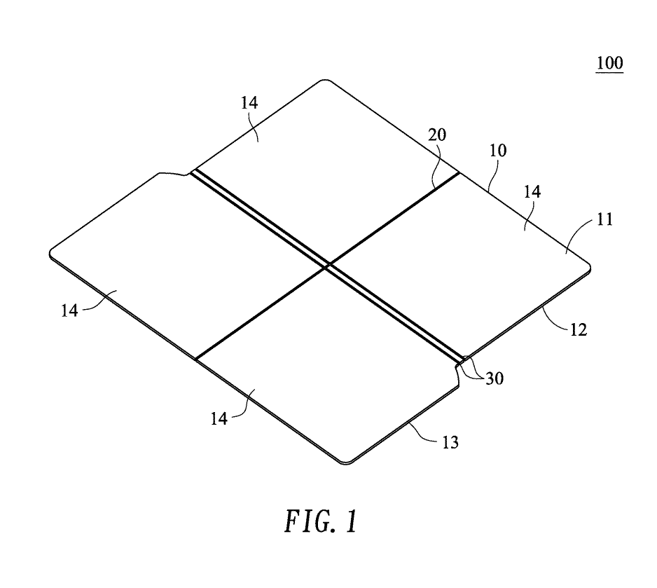

Please refer to FIG. 1, in an embodiment of the present invention, a foldable automotive antifouling mat structure 100 comprises a mat body 10, at least one first folding line 20, and at least one second folding line 30.

As shown in FIG. 1, mat body 10 can be formed of rubber, plastics or plastic material combined with carpet. Mat body 10 also includes an upper surface 11, a bottom surface 12 that is opposite to the upper surface 11 and plural edges 13 at the rim of the mat body 10. The number of the edges 13 or the shape of the mat body 10 depends upon the vehicle type and the applications required without any specific limitations.

While in applications, the mat body 10 can be placed on the floor or foot resting area in vehicle interior or on the cargo area with the bottom surface 12 of the mat body 10 attached to the floor, the foot resting area or the cargo area.

As shown in FIG. 1, at least one first folding line 20 being formed on the upper surface 11 of the mat body 10. Whichever two first folding lines 20 are parallel to each other when the number of the first folding line 20 is two or more than two.

Moreover, any first folding line 20 can be a groove or a trench formed on the upper surface 11 of the mat body 10, while in general, each first folding line 20 is formed as a straight line.

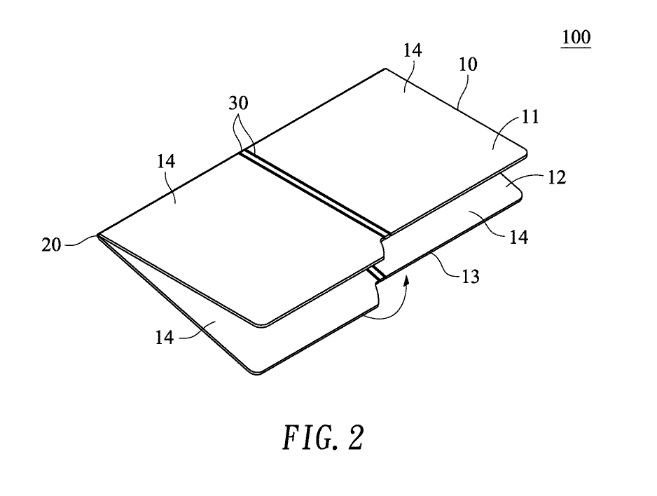

Please refer to FIG. 1 and FIG. 2, while requiring for packing, storage or transportation, a foldable automotive antifouling mat structure 100 can be folded along the first folding line 20 such that, after folded, the upper surface 11 of the mat body 10 is open to the outside air and the bottom surface 12 folded inside.

Referring again to FIG. 1, at least one second folding line 30 being also formed on the upper surface 11 of the mat body 10, wherein the second folding line 30 being perpendicularly crossing the first folding line 20.

The second folding line 30 can also be a groove or a trench formed on the upper surface 11 of the mat body 10, while in general, each second folding line 30 can also be in the shape of a straight line.

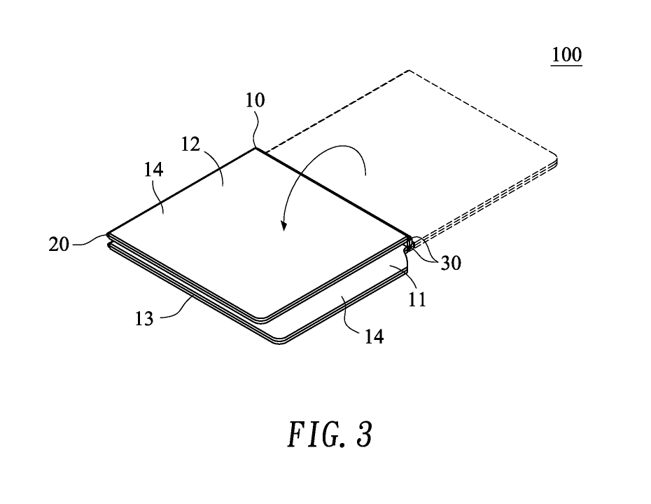

Please refer to FIG. 1, FIG. 2 and FIG. 3, while requiring for packing, storage or transportation, a foldable automotive antifouling mat structure 100 is folded along the first folding line 20, and then folded along the second folding line 30 or second folding lines 30, thus reduces the area or space required. Not only conveniences and reduce of cost of packing, storing or transporting can be achieved, but also the possibility of impacts, bending or deformation in storage or transporting is prevented.

As shown in FIG. 1 to FIG. 3, in a better embodiment for application, putting the thickness of the mat body 10 in consideration, the number of the first folding line 20 is one and the number of the second folding line 30 is two.

When the number of the second folding line 30 is two, the spacing of these two second folding lines 30 can be further arranged to comply with the thickness of the mat body 10 to make the folding of the foldable automotive antifouling mat structure 100 smooth and flat and occupies least space.

Thus, as shown in FIG. 3, the foldable automotive antifouling mat structure 100 can be folded without suffering from protruding issues.

As also shown in FIG. 1 to FIG. 3, the first folding line 20 and the second folding line 30 divide the mat body 10 into plural divisions 14, although the area of each different division 14 may not be the same due to the shape of the mat body 10, the first folding line 20 and the second folding line 30 can be designed or formed to make the area of each division 14 nearly identical to achieve best saving of space required for storage or transportation.

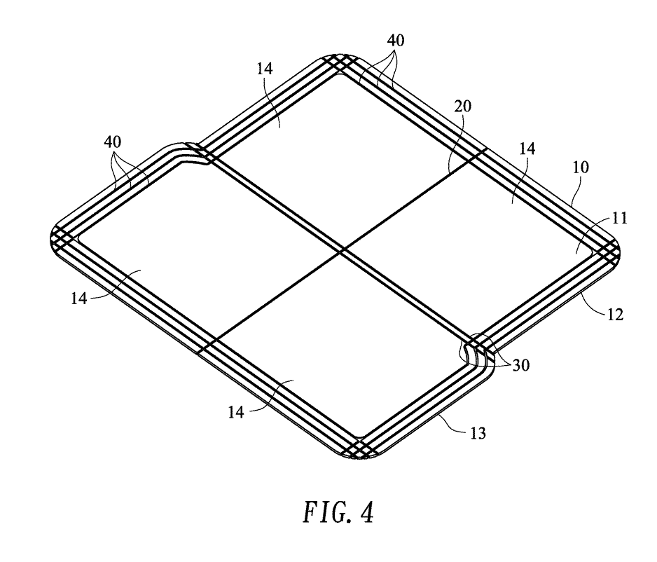

Please refer now to FIG. 4, at least one folding trench 40 can be formed on a part of the upper surface 11 close to an edge 13 of the mat body 10. With the folding trench 40, not only the resistance to pressure is increased, also the mat body 10 can be folded or bent along the folding trench 40 to more easily fit the foldable automotive antifouling mat structure 100 into different locations of applications.

The folding trench can also be formed as a groove, a sunken line or a protruding line on the upper surface 11. Different folding trenches 40 can be formed close to different edges 13, wherein the number of the folding trenches 40 can be one, two or more than two, and the folding trenches 40 close to the same edge 13 can be formed parallel to each other for bending convenience.

As shown in FIG. 4, different folding trenches 40 formed close to different edges 13 not parallel to each other can cross each other.

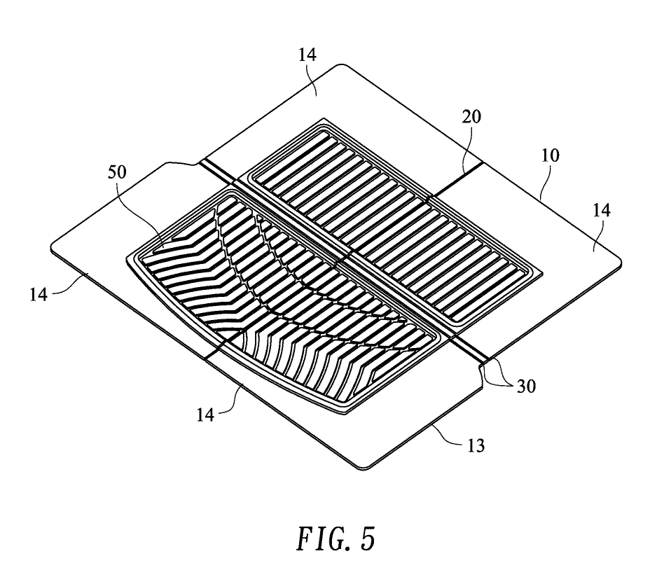

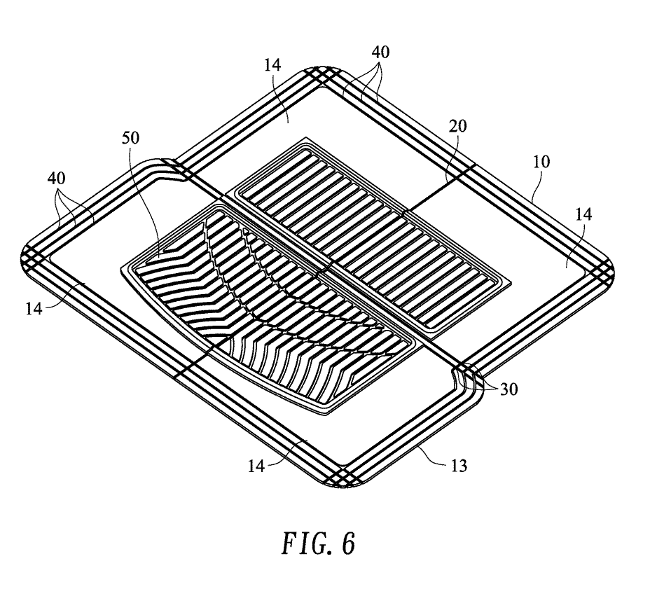

Moreover, as shown in FIG. 5 and FIG. 6, with or without folding trench 40, at least a pattern 50 can be formed on the upper surface 11 of the mat body 10 of a foldable automotive antifouling mat structure 100, wherein the pattern 50 formed being a concaved or a raised pattern 50 that is in a geometric or random shape.

As shown in FIG. 5 and FIG. 6, with said pattern 50 formed, foldable automotive antifouling mat structure 100 can be anti-skid and contain more fluid or debris. Besides, said pattern 50 can be formed on only part of the upper surface 11 of the mat body 10 or all over the upper surface 11 of the mat body 10.

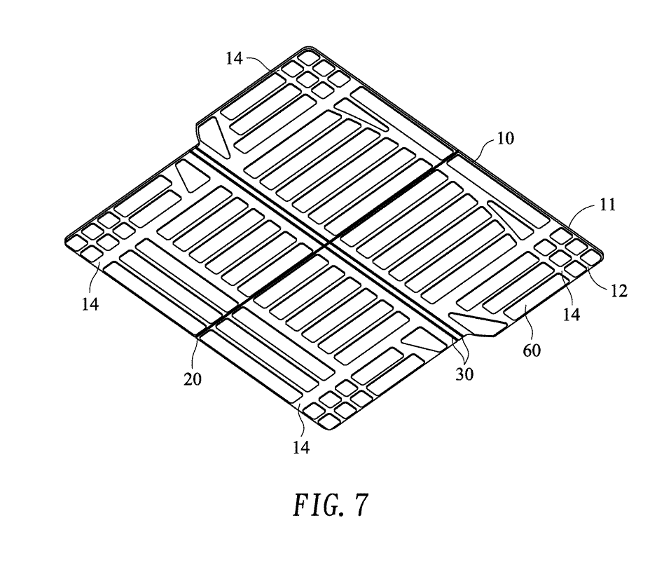

As now shown in FIG. 7, at least one anti-skid structure 60 can further be formed on the bottom surface 12 of the mat body 10. Anti-skid structure 60 prevents sliding of the foldable automotive antifouling mat structure 100 inside vehicle interior or cargo area, while anti-skid structure 60 can be formed integrally together with the mat body 10 or can be an anti-skid component adhered or attached to the bottom surface 12 of the mat body 10.

In conclusion, as indicated by the description of the aforesaid embodiments, the foldable automotive antifouling mat structure 100, which generally is made of a material light weight and unlikely to scratch the car body, incur low manufacturing costs, feature ease of use, and is effective in saving the space required for packing, storing or delivery/transportation and in preventing impact damage, bending or deformation. With further formation of folding trench 40 on the mat body 10, capability of fitting into different sizes of space is achieved to make further applications possible.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

1. A foldable automotive antifouling mat structure, comprising:
a mat body, including an upper surface, a bottom surface opposite to the upper surface and plural edges at the rim of the mat body;
one first folding line, forming on the upper surface; and
two second folding lines, forming on the upper surface and being perpendicularly crossing the first folding line.

2. The foldable automotive antifouling mat structure of claim 1, wherein the first folding line is a groove.

3. The foldable automotive antifouling mat structure of claim 1, wherein the second folding line is a groove.

4. (canceled)

5. (canceled)

6. The foldable automotive antifouling mat structure of claim 1, wherein the mat body is divided into plural areas by the first folding line and the second folding line.

7. The foldable automotive antifouling mat structure of claim 1, wherein at least one folding trench is formed on a part of the upper surface close to at least one of the edges.

8. The foldable automotive antifouling mat structure of claim 7, wherein the number of the folding trench is 2 or is greater than 2, wherein any two of the folding trenches are parallel to each other.

9. The foldable automotive antifouling mat structure of claim 1, wherein at least one pattern is formed on the upper surface.

10. The foldable automotive antifouling mat structure of claim 1, wherein at least one anti-skid structure is formed on the bottom surface, wherein the antiskid structure being integrally formed together with the mat body.

11. The foldable automotive antifouling mat structure of claim 1, wherein at least one anti-skid structure is formed on the bottom surface, wherein the antiskid structure being an antiskid part attached to the bottom surface.

12. The foldable automotive antifouling mat structure of claim 4, wherein at least one pattern is formed on the upper surface.

13. The foldable automotive antifouling mat structure of claim 4, wherein at least one anti-skid structure is formed on the bottom surface, wherein the antiskid structure being integrally formed together with the mat body.

14. The foldable automotive antifouling mat structure of claim 4, wherein at least one anti-skid structure is formed on the bottom surface, wherein the antiskid structure being an antiskid part attached to the bottom surface.

15. The foldable automotive antifouling mat structure of claim 5, wherein at least one pattern is formed on the upper surface.

16. The foldable automotive antifouling mat structure of claim 5, wherein at least one anti-skid structure is formed on the bottom surface, wherein the antiskid structure being integrally formed together with the mat body.

17. The foldable automotive antifouling mat structure of claim 5, wherein at least one anti-skid structure is formed on the bottom surface, wherein the antiskid structure being an antiskid part attached to the bottom surface.

18. The foldable automotive antifouling mat structure of claim 7, wherein at least one pattern is formed on the upper surface.

19. The foldable automotive antifouling mat structure of claim 7, wherein at least one anti-skid structure is formed on the bottom surface, wherein the antiskid structure being integrally formed together with the mat body.

20. The foldable automotive antifouling mat structure of claim 7, wherein at least one anti-skid structure is formed on the bottom surface, wherein the antiskid structure being an antiskid part attached to the bottom surface.
